(19) United States
(12) Patent Application Publication
(10) Pub. No.: US 2025/0311049 A1
(43) Pub. Date: Oct. 2, 2025

(54) METHOD FOR ENABLING WIRELESS COMMUNICATION DEVICE TO ACCESS SERVICES PROVIDED BY RADIO ACCESS NETWORK AND RELATED DEVICES

(71) Applicant: PURPLEVINE INNOVATION COMPANY LIMITED, Hongkong (HK)

(72) Inventor: Yi-Ting LIN, Hongkong (HK)

(73) Assignee: PURPLEVINE INNOVATION COMPANY LIMITED, Hongkong (HK)

(21) Appl. No.: 18/864,505

(22) PCT Filed: May 11, 2023
(86) PCT No.: PCT/CN2023/093666

§ 371 Date: Nov. 8, 2024

Related U.S. Application Data
(60) Provisional application No. 63/340,509, filed on May 11, 2022.
(60) Provisional application No. 63/381,371, filed on Oct. 28, 2022.

(51) Int. Cl. H04W 76/28; H04L 43/087

(52) U.S. Cl. CPC H04W 76/28; H04L 43/087

(57) ABSTRACT

A method for enabling a wireless communication device to access services provided by a Radio Access Network, a user equipment (UE), a base station (BS) and a non-transitory computer readable storage medium are provided. In the method, a discontinuous reception (DRX) cycle is configured with a DRX ON period for transmission of at least one of control information or data and a DRX OFF period during which the transmission is suspended, and specifically the DRX cycle is a specific DRX cycle having a non-integer duration. This can eliminate a mismatch between burst arrival interval and the DRX cycle to adapt the EXtended Reality (XR)/Cloud Gaming (CG) traffic, for example.

### TECHNICAL FIELD

The present application relates to wireless communication, and more particularly, to a method for enabling a wireless communication device to access services provided by a Radio Access Network, and related devices such as a user equipment (UE) and a base station (BS).

### BACKGROUND ART

This background section introduces aspects that may facilitate a better understanding of the disclosure. Accordingly, the statements of this section are to be read in this light and are not to be understood as admissions about what is in the prior art or what is not in the prior art.

Communication systems and networks have developed towards being a broadband and mobile system. In cellular wireless communication systems developed by the Third Generation Partnership Project (3GPP), user equipment (UE) is connected by a wireless link to a radio access network (RAN). The RAN includes a set of base stations (BSs) which provide wireless links to the UEs located in cells covered by the base station, and an interface to a core network (CN) which provides overall network control. As will be appreciated the RAN and CN each conduct respective functions in relation to the overall network. The 3GPP has developed the so-called Long Term Evolution (LTE) system, namely, an Evolved Universal Mobile Telecommunication System Territorial Radio Access Network (E-UTRAN), for a mobile access network where one or more macro-cells are supported by a base station known as an eNodeB or eNB (evolved NodeB). More recently, evolved from LTE, the so-called 5G or New radio (NR) systems where one or more cells are supported by a base station known as a gNB.

The 5G NR standard supports a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

During 3GPP Rel-17, traffic pattern for EXtended Reality (XR) and Cloud Gaming (CG) was studied. The characteristics of XR/CG traffic include small traffic periodicity with jitter, large packet size, different traffic pattern between uplink (UL) and downlink (DL). The existing power saving mechanisms for Enhanced Mobile Broadband (eMBB) and Ultra-Reliable and Low Latency Communications (URLLC) may not be directly applied to XR/CG service. A 3GPP Rel-18 Work Item (WI) on Study on XR Enhancements for NR (FS_NR_XR_enh) was approved to study how to enhance the standard specifications for XR/CG services. According to the objectives of the WID for Rel-18 IoT NTN, how to enhance the existing power saving mechanisms e.g., connected mode discontinuous reception (CDRX), Physical Downlink Control Channel (PDCCH) monitoring for the UEs using XR services is an important issue to be resolved.

EXtended Reality (XR) and Cloud Gaming (CG) are important services for New Radio (NR) in Rel-18 and beyond. Cloud Gaming (CG) is a type of online gaming that runs video games where most computations related to gaming are offloaded from the UE to remote server(s). Extended reality (XR) is a term referring to all real-and-virtual combined environments combined with human-to-human and human-to-machine communications through handheld and wearable UEs. The XR use cases may include augmented reality (AR), virtual reality (VR), and mixed reality (MR). While XR and CG offer an attractive set of use cases for future mobile systems, they also present NR with a set of challenges that need to be studied and potentially addressed.

Many XR and CG use cases are presented by video streaming which is characterized by quasi-periodic traffic with possible jitter and high data rate in downlink (DL) combined with the frequent uplink (UL) (i.e., pose/control update) and/or UL video streaming. DL and UL traffic are also characterized by a relatively tight packet delay budget (PDB). Therefore, it is necessary to study and specify possible solutions to better support these challenging services.

Many of the end-user XR and CG devices are expected to be mobile and of small-scale, thus having limited battery power resources. Therefore, additional power enhancements may be required to reduce the overall UE power consumption when running XR and CG services, thereby extending the effective UE battery lifetime. It is understood that the current discontinuous reception (DRX) configurations are not suitable for (i) the non-integer XR traffic periodicity, (ii) variable XR data rate and (iii) quasi-periodic XR periodicity with jitter, so DRX enhancements would be beneficial for UE power consumption.

The typical XR DL frame rates are 60, 90, or 120 frames per seconds (fps) with frame periodicities of 16.67 ms, 11.11 ms, and 8.33 ms, respectively. The configurable long cycle values of Rel-15/16 connected mode DRX (CDRX) are 10, 20, 32, 40, 60 ms, etc. and short cycle values are 2, 3, 4, 5, 6, 7, 8, 10, 14, 16, 20, 30, 32, 35, 40 ms, etc. Since CDRX cycle values support only integer multiples of 1 ms, whichever cycle periodicity is chosen from currently available values, it cannot be perfectly aligned with DL frame arrival timing. FIG. 1 illustrates the case of mismatch between 60 fps and DRX cycles. For the case of 16 ms DRX cycle, the traffic will gradually arrive behind the DRX ON period. For the case of 17 ms DRX cycle, instead, the traffic will gradually arrive earlier than the DRX ON period. This mismatch would lead to XR capacity loss due to larger latency and/or larger UE power consumption to keep the same latency performance.

The technical problems can be briefly summarized as how to enhance the current DRX configuration to adapt the XR/CG traffic, and how does the eNB/UE precisely configure and/or adjust the DRX configuration(s) based on the XR/CG traffic characteristics, in which the traffic characteristics may include multiple streams with non-integer periodicities and arrival time jitter.

Therefore, there is an urgent need to develop a new approach to solve above problems.

### RELATED ARTS

### Discontinuous Reception (DRX)

DRX is a method used in cellular communication to conserve the battery power of the UE. DRX in LTE/NR is introduced to improve UE power consumption by allowing the UE to periodically enter OFF state to stop monitoring Physical Downlink Control Channel (PDCCH). During the OFF state, the UE turns off its receiver such that UE power consumption is reduced. The UE wakes up periodically during ON state to monitor PDCCH for downlink (DL) data reception. The interval of the ON state (i.e., or called ON period) is configured by the RRC parameter, drx-onDurationTimer. An ON period and an OFF period makes up a DRX cycle which is illustrated in FIG. 2.

The triggering condition for a DRX cycle is as follows:

When short DRX is configured as illustrated in FIG. 3 and data transmission/reception occurs in the previous ON period, the next ON period starts at a subframe satisfying

$$[ ( SFN \times 10 ) + subframe number ] mod ( drx - ShortCycle ) = ( drx - StartOffset ) mod ( drx - ShortCycle )$$

where SFN stands for system frame number (SFN). The actual ON period starts after a certain slot offset which is configured by the RRC parameter, drx-slotoffset. The value of drx-slotoffset ranges of 0-31 and is in units of 1/32 ms. drx-ShortCycle defines the short DRX cycle configured for the UE and its value ranges of 2-640 ms. drx-startoffset indicates the start subframe of the short DRX cycle and its value is in units of 1 ms.

When the drx-ShortCycleTimer (i.e., number of short DRX cycles and the number ranges from 1 to 16) is expired or a short DRX cycle is not configured, the UE uses a long DRX cycle.

The ON period of the long DRX cycle at a subframe satisfying

$$[ ( SFN \times 10 ) + subframe number ] mod ( drx - LongCycle ) = ( drx - StartOffset )$$

where drx-LongCycle defines the long DRX cycle configured for the UE, and its value ranges from 10 to 10240 ms. Long DRX cycle configuration is the default for DRX, and a short DRX cycle configuration is optional. When a short DRX cycle is configured, a long DRX cycle duration is an integer multiple of the short DRX cycle duration.

### SUMMARY

In a first aspect, an embodiment of the present application provides a method for enabling a wireless communication device to access services provided by a Radio Access Network, wherein a discontinuous reception (DRX) cycle is configured with a DRX ON period for transmission of at least one of control information or data and a DRX OFF period during which the transmission is suspended, and wherein the DRX cycle is a specific DRX cycle having a non-integer duration.

In a second aspect, an embodiment of the present application provides a method for enabling a wireless communication device to access services provided by a Radio Access Network, wherein a DRX cycle is configured with a DRX ON period for transmission of at least one of control information or data and a DRX OFF period during which the transmission is suspended, and wherein the DRX cycle is modified based on burst arrival interval to eliminate a mismatch between the burst arrival interval and the DRX cycle.

In a third aspect, an embodiment of the present application provides a method for enabling a wireless communication device to access services provided by a Radio Access Network, wherein a discontinuous reception (DRX) cycle is configured with a DRX ON period for transmission of at least one of control information or data and a DRX OFF period during which the transmission is suspended, and wherein the DRX ON period of the DRX cycle is extended to cover an arrival interval of at least one data burst plus a data arrival jitter.

In a fourth aspect, an embodiment of the present application provides a method for enabling a wireless communication device to access services provided by a Radio Access Network, wherein physical downlink control channel (PDCCH) monitoring periodicity is dynamically changed based on an search space set group (SSSG) switch indication, and wherein at least two search spaces are configured, one of the at least two search spaces is for sparse PDCCH monitoring and the other one of the at least two search spaces is for dense PDCCH monitoring.

In a fifth aspect, an embodiment of the present application provides a method for enabling a wireless communication device to access services provided by a Radio Access Network, wherein multiple discontinuous reception (DRX) configurations with different start offsets and different DRX cycles are configured, and wherein one of the multiple DRX configurations is activated at a time.

In a sixth aspect, an embodiment of the present application provides a method for enabling a wireless communication device to access a multi-modality service provided by a Radio Access Network, wherein a discontinuous reception (DRX) configuration for a variable-sized stream, a semi-persistent scheduling (SPS) configuration for a downlink (DL) fixed-sized stream, and a configured grant (CG) configuration for an UL fixed-sized stream are configured for the multi-modality service.

In a seventh aspect, an embodiment of the present application provides a user equipment (UE), including: a memory, configured to store program instructions; a transceiver, configured to transmit and receive data; and a processor, coupled to the memory and the transmitter, configured to call and run the program instructions stored in a memory, to cooperate with the memory to execute the method of any of afore-described aspects.

In an eighth aspect, an embodiment of the present application provides a base station (BS), including: a memory, configured to store program instructions; a transceiver, configured to transmit and receive data; and a processor, coupled to the memory and the transmitter, configured to call and run the program instructions stored in a memory, to cooperate with the memory to execute the method of any of afore-described aspects.

In a ninth aspect, an embodiment of the present application provides a non-transitory computer readable storage medium, configured to store a computer program, which enables a computer to execute the method of any of afore-described aspects.

In a tenth aspect, an embodiment of the present application provides a computer readable storage medium provided for storing a computer program, which enables a computer to execute the method of any of afore-described aspects.

In an eleventh aspect, an embodiment of the present application provides a computer program product, which includes computer program instructions enabling a computer to execute the method of any of afore-described aspects.

In a twelfth aspect, an embodiment of the present application provides a computer program, when running on a computer, enabling the computer to execute the method of any of afore-described aspects.

### DESCRIPTION OF DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a schematic diagram illustrating a mismatch between XR DL traffic (60 fps) and legacy CDRX periodicity (16 and 17 ms).

FIG. 2 is a schematic diagram illustrating a long DRX configuration.

FIG. 3 is a schematic diagram illustrating a short DRX configuration.

FIG. 4 is a block diagram illustrating one or more UEs, a base station and a network entity device in a communication network system according to an embodiment of the present application.

FIG. 5 is a schematic diagram illustrating radio protocol architecture within gNB and UE.

FIG. 6 is a schematic diagram illustrating a gNB further including a centralized unit (CU) and a plurality of distributed unit (DUs).

FIG. 7 is a schematic diagram illustrating PDU classification for a video stream in 3GPP network.

FIG. 8 is a schematic diagram illustrating DRX cycle modified based on the burst arrival interval.

FIG. 9 is a schematic diagram illustrating the first subframe number of the ON period when the short DRX cycle=16 ms.

FIG. 10 is a schematic diagram illustrating the first subframe number of the ON period when the short DRX cycle=16 ms with T=2 ms.

FIG. 11 is a schematic diagram illustrating the first subframe number of the ON period when the short DRX cycle=16 ms.

FIG. 12 is a schematic diagram illustrating a DRX configuration with {16 ms, 17 ms, 17 ms}periodicities composed by three DRX configurations with {Oms, 16 ms, 33 ms}start offsets.

FIG. 13 is a schematic diagram illustrating ON period adjusted to accommodate the jitter.

FIG. 14 is a schematic diagram illustrating inner short cycles configured within another outer long cycle.

FIG. 15 is a schematic diagram illustrating PDCCH-based power saving for XR/CG.

FIG. 16 is a schematic diagram illustrating PDCCH-based power saving for XR/CG.

FIG. 17 is a schematic diagram illustrating PDCCH-based power saving combined with DRX-based power saving.

FIG. 18 is a schematic diagram illustrating multiple DRX configurations.

FIG. 19 is a schematic diagram illustrating a DRX configuration with a CG configuration and a SPS configuration for a multi-modality service.

FIG. 20 is a schematic diagram illustrating initiate/update the DRX configuration(s) for a UE.

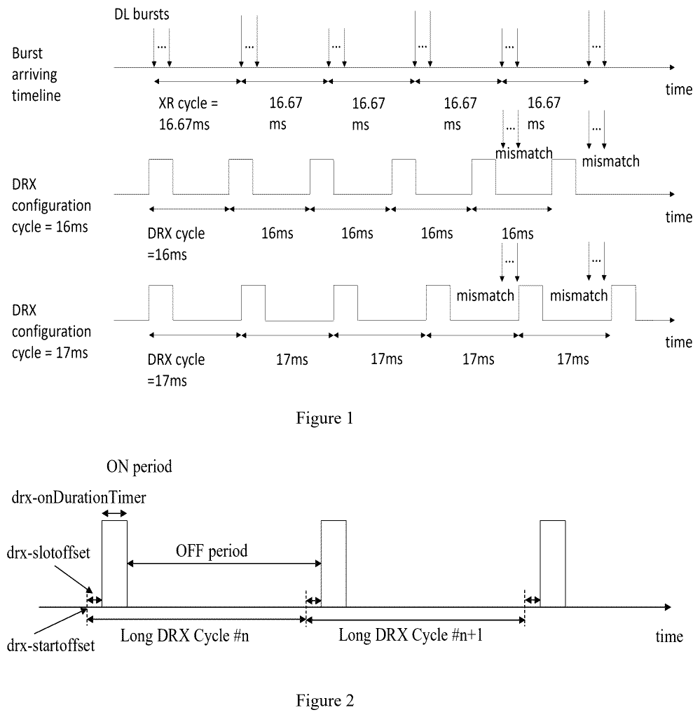

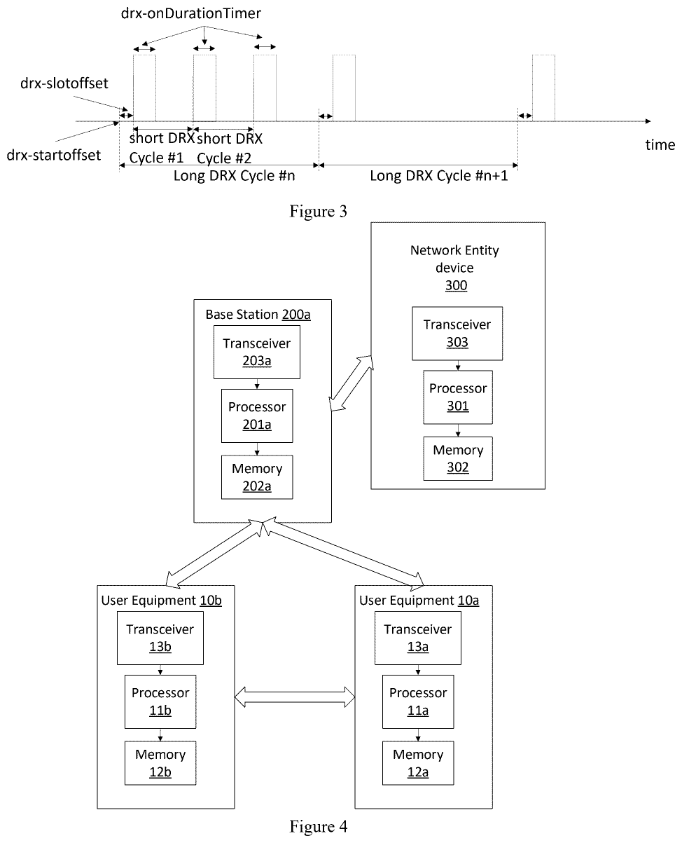

### DETAILED DESCRIPTION OF EMBODIMENTS

Embodiments of the disclosure are described in detail with the technical matters, structural features, achieved objects, and effects with reference to the accompanying drawings as follows.

Specifically, the terminologies in the embodiments of the present application are merely for describing the purpose of the certain embodiment, but not to limit the disclosure.

This invention realizes DRX enhancements in many aspects as follows.
The traffic burst in 3GPP network for a video stream.

Describe the composition and characteristics of a video stream in 3GPP networks. Each frame of the video stream is classified into a PDU set, which is then mapped to a QoS (sub)flow and a DRB and logical channel(s).

### Configure a Specific DRX Cycle for a Video Stream.

A video stream of the XR/CG service is configured with a non-integer DRX cycle. The non-integer value needs to be specified in standard specification.

### Modified the DRX Cycle Based on the Triggering Equation.

Fine-tune the DRX cycle within a fixed long cycle. The triggering equation may be specified in standard specification.

### Modified the DRX Cycle by Configuring Multiple DRX Configurations.

Multiple DRX configurations for XR/CG service needs to be specified in standard specification.

### Handling Jitter of Traffic Arrival Time.

Large ON period is configured to cover most of the arrival times. During the ON period, short DRX cycles or different search spaces are configured to reduce the time for PDCCH monitoring.

### Supporting Multi-Modality Service for XR/CG.

Multiple DRX configurations for XR/CG service may be specified in standard specification.

Based on the proposed DRX enhancements, the UE could save power consumption while supporting multi-modality service for XR/CG applications.

FIG. 4 illustrates that, in some embodiments, one or more user equipments (UEs) 10a, 10b, a base station (e.g., gNB or eNB) 200a and a network entity device 300 for wireless communication in a communication network system according to an embodiment of the present application are provided. With reference to FIG. 4, a UE 10a, a UE 10b, a base station 200a, and a network entity device 300 executes embodiments of the method according to the present application.

Connections between devices and device components are shown as lines and arrows in the FIG. 4. The UE 10a may include a processor 11a, a memory 12a, and a transceiver 13a. The UE 10b may include a processor 11b, a memory 12b, and a transceiver 13b. The base station 200a may include a processor 201a, a memory 202a, and a transceiver 203a. The network entity device 300 may include a processor 301, a memory 302, and a transceiver 303. Each of the processors 11a, 11b, 201a, and 301 may be configured to implement proposed functions, procedures and/or methods described in this description. Layers of radio interface protocols may be implemented in the processors 11a, 11b, 201a, and 301. Each of the memory 12a, 12b, 202a, and 302 operatively stores a variety of program and information to operate a connected processor. Each of the transceiver 13a, 13b, 203a, and 303 is operatively coupled with a connected processor, transmits and/or receives radio signals. The base station 200a may be an eNB, a gNB, or one of other radio nodes.

Each of the processor 11a, 11b, 201a, and 301 may include a general-purpose central processing unit (CPU), an application-specific integrated circuits (ASICs), other chipsets, logic circuits and/or data processing devices. Each of the memory 12a, 12b, 202a, and 302 may include a read-only memory (ROM), a random access memory (RAM), a flash memory, a memory card, a storage medium, other storage devices, and/or any combination of the memory and storage devices. Each of the transceiver 13a, 13b, 203a, and 303 may include baseband circuitry and radio frequency (RF) circuitry to process radio frequency signals. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

The network entity device 300 may be a node in a central network (CN). The CN may include LTE CN or 5G core (5GC) which may include user plane function (UPF), session management function (SMF), access and mobility management function (AMF), unified data management (UDM), policy control function (PCF), control plane (CP)/user plane (UP) separation (CUPS), authentication server function (AUSF), network slice selection function (NSSF), the network exposure function (NEF), and other network entities.

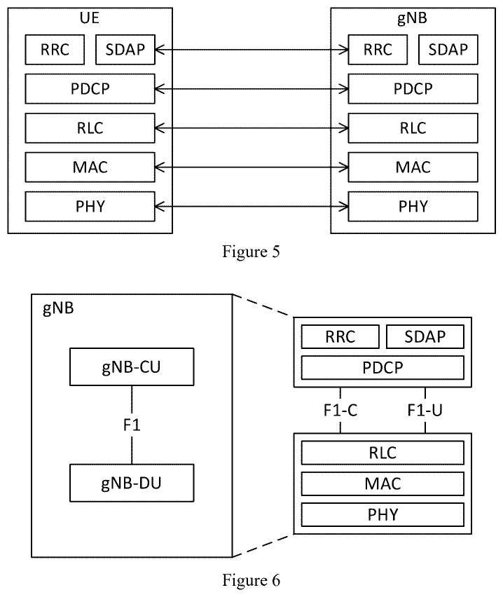

The radio protocol architecture within the base station (gNB) and UE is shown in FIG. 5, which includes Radio Resource Control (RRC), Service Data Adaptation Protocol (SDAP), Packet Data Convergence Protocol (PDCP), Radio Link Control (RLC), Medium Access Control (MAC), and Physical Layer Protocol (PHY). In RAN functional split, the gNB further includes a centralized unit (CU) and a plurality of distributed unit (DUs) as shown in FIG. 6. The protocol stack of CU includes an RRC layer, an optional SDAP layer, and a PDCP layer, while the protocol stack of DU includes an RLC layer, a MAC layer, and a PHY layer. The F1 interface between the CU and DU is established between the PDCP layer of the protocol stack and the RLC layer of the protocol stack.

### The Traffic Burst in 3GPP Network for a Video Stream.

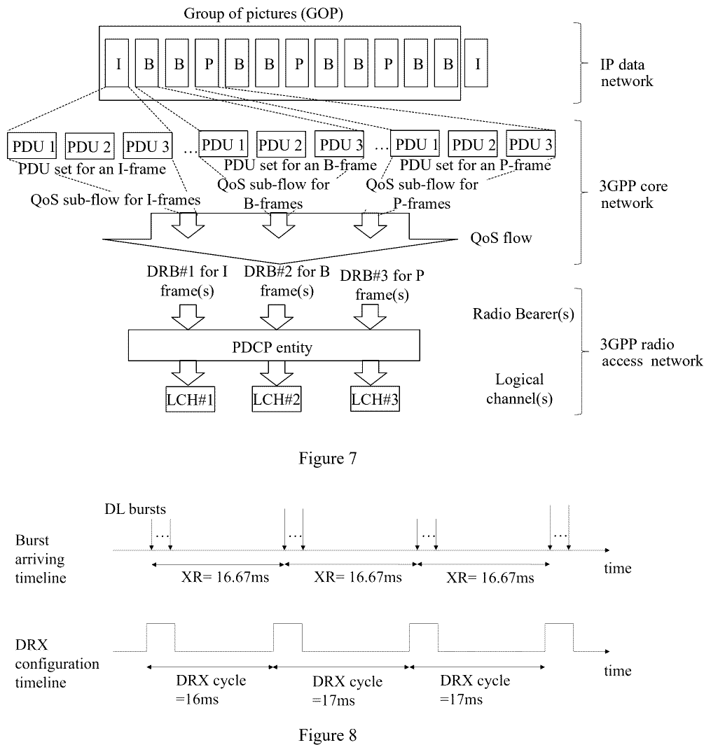

FIG. 7 shows how a group of pictures (GOP) are transmitted from an Internet Protocol (IP) data network to 3GPP radio access network (RAN). A video stream from the XR/CG application may consist of a series of I-frame, B-frame, and P-frame. An I-frame carries a fully independently encoded picture and B/P-frame carries a picture based on a previous or next picture. Each frame may consist of several IP packets (around 1500 bytes) based on the frame type. When a frame (i.e., several IP packets) enters 3GPP network (e.g., user plane function (UPF)), it is encapsulated into several General Packet Radio Service (GPRS) Tunneling Protocol user plane (GTP-U) protocol data units (PDUs), and the PDUs (for a frame) may form a PDU set. The PDUs in a PDU set share the same Quality of Service (QoS) characteristics such as packet size, delay budget, delay jitter, priority, etc. The PDUs in different PDU sets may use different QoS requirements. The PDUs in different PDU sets may be classified to different sub-flows in a QoS flow. (i.e., the PDUs in different PDU sets may share the same 5-tuple but with different priority) The PDUs in different PDU sets may also be classified to different QoS flows in case sub-flows are not supported. In such case, the header of each PDU should indicate which PDU set it belongs to.

When the PDUs enters 3GPP radio access network, the Service Data Adaptation Protocol (SDAP) layer of the gNB maps the sub-flows (or QoS flows) to different data radio bearers (DRBs). Each DRB is configured with QoS parameters (i.e., PDU set delay budget, PDU set error rate, priority, etc.) which may be different from the ones of the other DRB. The gNB creates a Packet Data Convergence Protocol (PDCP) entity for each sub-flow (or QoS flow) to map the PDUs in each DRB to an associated logical channel for the DRB. The benefit of this case is that the legacy mapping between a QoS flow and a DRB could be reused.

In an alternative implementation, the sub-flows (or QoS flows) are mapped to the same DRBs. In such case, the PDUs share the same QoS parameters because they belong to the same DRB. The PDCP entity should be able to distinguish the PDUs in different PDU set and map the PDUs to appropriate logical channel(s). The benefit of this case is that in-order delivery of the PDUs can be guaranteed.

According to the priority of each DRB, the PDCP entity may configure one or more Radio Link Control (RLC) entities for each DRB. For example, I-frames have high priority, and the PDCP can configure multiple RLC entities (e.g., 2 or 4) with associated logical channel(s) for the DRB to enable PDCP duplication, thereby increasing the reliability of I-frames.

At the Medium Access Control (MAC) layer, PDUs from each logical channel (LCH) are encapsulated into MAC PDUs waiting to be scheduled to the UE.

### Configure a Specific DRX Cycle for a Video Stream.

For a video stream of the XR/CG service, a DRX cycle is configured, which is a non-integer DRX cycle. The DRX cycle can be a short DRX cycle or a long DRX cycle. The DRX cycle is configured with a DRX ON period for transmission of at least one of control information or data and a DRX OFF period during which the transmission is suspended, and specifically the DRX cycle is a specific DRX cycle having a non-integer duration. The specific DRX cycle is configured for a specific use case (for example, the XR/CG service) and is a non-integer value listed in an information element. That is, the non-integer value may be specified in standard specification. For example, the non-integer duration is 33.33, 16.67, 11.11 or 8.33 in a unit of microsecond. In case the specific DRX cycle is a short DRX cycle, a corresponding long DRX cycle may added in the information element, and a duration of the long DRX cycle is an integer multiple of a duration of the short DRX cycle. The specific DRX cycle may obtained by combining an integer part corresponding to one DRX cycle listed in the information element and a decimals part selected from possible decimals listed in the information element. For example, the decimals part is a rational number. Further details are provided below.

Based on the frame rate (i.e., 60, 90, or 120 fps), a series of MAC PDUs are generated periodically (i.e., every 16.67 ms, 11.11 ms, 8.33 ms) for a video stream. The gNB may configure a DRX for the UE to periodically receive the MAC PDUs. The UE wakes up during the DRX ON period to receive the MAC PDUs and go to sleep (i.e., the UE suspends monitoring of PDCCH) during the DRX OFF period for power saving. Table 1 below shows the possible configurations of long and short DRX cycles in the current 3GPP Technical Specification (TS) 38.331. In the current specification, only integer-valued periodicities can be configured for DRX cycles. To provide a non-integer periodicity, the most straightforward way is to add a new value for the long/short DRX cycle. However, enumerating all non-integer values is very difficult and inefficient. Non-integer settings such as ⅓, ⅙, 1/9 etc. are required to cover the periodicities for 30, 60, 90, and 120 fps.

TABLE 1
Long and short DRX cycle in TS 38.331.

| | |
|---|---|
| drx-LongCycleStartOffset | CHOICE { |
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |

},

| | |
|---|---|
| shortDRX | SEQUENCE { |
| drx-ShortCycle | ENUMERATED { |
| | ms2, ms3, ms4, ms5, ms6, ms7, ms8, |

ms10, ms14, ms16, ms20, ms30, ms32, ms35, ms40, ms64, ms80, ms128,
ms160, ms256, ms320, ms512, ms640, spare9, spare8, spare7, spare6,
spare5, spare4, spare3, spare2, spare1 },

One of the solutions is to add a configuration for each of the traffic arrival patterns. (i.e., 30, 60, 90, 120 fps) Four short DRX cycles, which are 33.33 ms, 16.67 ms, 11.11 ms, 8.33 ms for 30, 60, 90, 120 fps respectively, can be configured as extensions for Rel-18 drx-ShortCycle, for example. Although the extensions are configured for short DRX cycles as listed in Table 2 below, it does not limit the extensions configured for long DRX cycles.

TABLE 2
Short DRX cycle information element.

| | |
|---|---|
| shortDRX | SEQUENCE { |
| drx-ShortCycle-r18 | ENUMERATED { |
| | ms33dot33, ms16dot67, ms11dot11, |

ms8dot33, spare4, spare3, spare2, spare1 },

The corresponding Long DRX cycle should be added because the long DRX cycle duration is an integer multiple of a short DRX cycle duration. Some examples of the long DRX cycles are listed in Table 3 below.

TABLE 3
Long DRX cycle with start offset.

| | |
|---|---|
| drx-LongCycleStartOffset-r18 | CHOICE { |
| ms100 | INTEGER(0..99), |
| ms200 | INTEGER(0..199), |
| ms400 | INTEGER(0..399), |
| ms800 | INTEGER(0..799), |
| ms1000 | INTEGER(0..999), |
| ms2000 | INTEGER(0..1999), |
| ms4000 | INTEGER(0..3999), |
| ms8000 | INTEGER(0..7999), |
| ms10000 | INTEGER(0..9999), |

},

The other one solution is to combine the integer part in the existing short DRX cycles and the decimals part in the extension. Take the 16.67 ms of short DRX cycle as an example, the integer part in drx-ShortCycle (i.e., 16 ms) and the decimals part in drx-ShortCycle-r18 (i.e., ⅔ ms) make up the short DRX cycle of 16.67 ms. Table 4 below lists the possible decimals of the short DRX cycle for the XR/CG use cases.

TABLE 4
Short DRX cycle information element.

| | |
|---|---|
| shortDRX | SEQUENCE { |
| drx-ShortCycle-r18 | ENUMERATED { |
| | zero, msoneHalf, msoneThird, msoneFouth, |

msoneFifth, msoneSixth, msoneSeventh, msoneEighth, msoneNinth,
msoneTenth, mstwoThird, spare5, spare4, spare3, spare2, spare 1 },

Configure a specific DRX cycle for a specific use case is the most straightforward method, but the disadvantage is that as the number of use cases increase, the number of DRX cycles in the configuration also increases. However, this method supports specific use cases in a simple way without a major revision on the standard.

### Modified the DRX Cycle Based on the Triggering Equation.

For a video stream of the XR/CG service, a DRX cycle is configured. The DRX cycle can be a short DRX cycle or a long DRX cycle. The DRX cycle is configured with a DRX ON period for transmission of at least one of control information or data and a DRX OFF period during which the transmission is suspended, and specifically the DRX cycle is modified based on burst arrival interval. In particular, the DRX cycle is fine-tuned in periodicities by a triggering equation to eliminate a mismatch between the burst arrival interval and the DRX cycle. The triggering equation may be specified in standard specification. According to the triggering equation, the DRX cycle may be modified according to a cumulative difference between the burst arrival interval and the configured DRX cycle. The cumulative difference may be normalized by a predefined time interval. In particular, the (minimal) difference between the burst arrival interval and the configured DRX cycle can be less than 1 (a real number between 0 and 1) and can be not less than 1 (a real number larger than 1). The DRX cycle may configured with an integer (listed in an information element) less than or equal to the burst arrival interval. The DRX cycle maybe configured by a short DRX cycle information element or a long DRX cycle information element. Alternatively, the DRX cycle may be configured with a real number (which may or may not listed in the information element). According to the triggering equation, a counter for a number of system frame number (SFN) wrap-around may be added to the triggering equation. The DRX cycle based on the burst arrival interval may be provided by a user equipment (UE) and/or an application server to a base station for configuring the DRX cycle. Further details are provided below.

This method does not directly configure a new DRX cycle but modifies the DRX cycle in some periodicities by the triggering equation. The advantage of this method is that legacy DRX parameters (e.g., DRX cycle, start offset, slot offset, etc.) could be reused and decimals value of the DRX cycle could be achieved through adjusting the remainder of the mod function in the triggering equation. However, the new triggering equation may have impact on the legacy equation. To indicate the UE to use the new triggering equation, some parameters (e.g., DRX indication for XR/CG or δₙ) may be configured for the UE by the Radio Resource Control (RRC) messages.

Take 60 fps as an example, the burst arrival interval is 16.67 ms. FIG. 8 shows that the DRX cycle needs to be modified by 2 ms every 50 ms to eliminate the mismatch between the burst arrival interval and the DRX cycle. In order to modify the DRX cycle, the triggering equation should be modified as:

[(SFN×10)+subframe number] mod (drx-ShortCycle)=(drx-StartOffset+δₙ) mod (drx-ShortCycle),
where δₙ=round [n·(burst arrival interval−DRX cycle)], n counts the number of DRX cycle and starts from zero, and the DRX cycle is configured with an integer less than or equal to the burst arrival interval. An offset of the start time of a DRX cycle to the starting point of system frame (i.e., SFN=0 and subframe=0) is represented by drx-StartOffset.

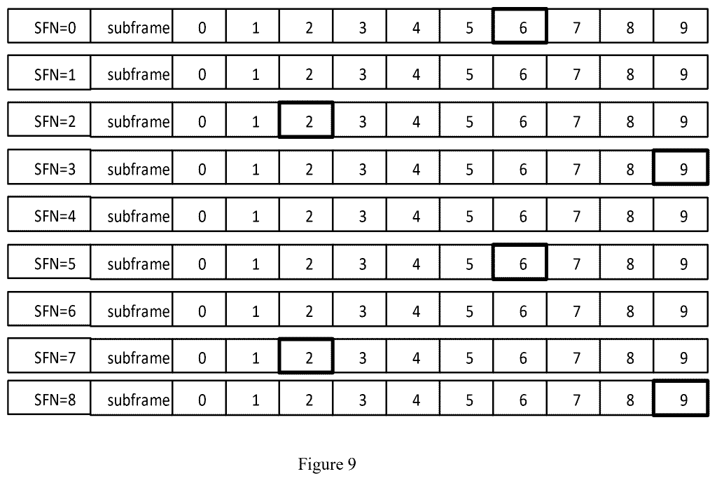

Assume the burst arrival interval is 16.67 ms, the short DRX cycle could be configured as 16 ms, and the drx-StartOffset is configured as 6. FIG. 9 shows the first subframe number of the ON period of the short DRX cycle. The short DRX cycle is modified by the triggering equation to 16 ms, 17 ms, and 17 ms. Note that a short DRX cycle is an example here and we do not restrict the use of a long DRX cycle.

The triggering equation may be modified as follows to adjust the DRX cycle when the difference between the burst arrival interval and the DRX cycle exceeds T ms.

$${δ}_{n} = round [ \frac{n \cdot ( burst arrival interval - DRX cycle )}{T} ] \cdot T$$

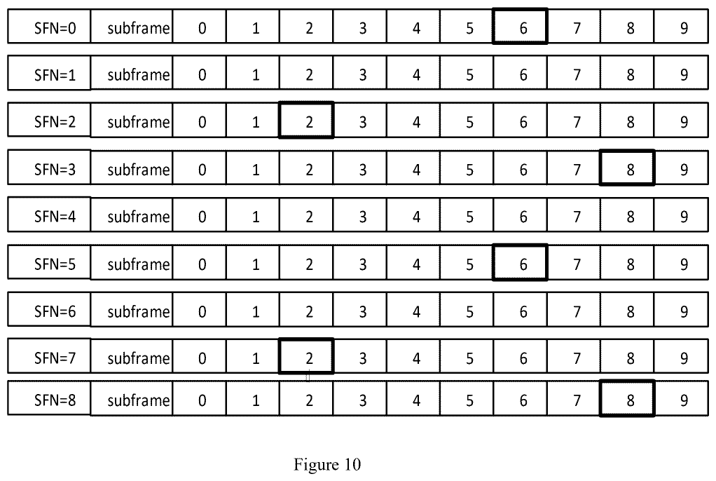

The short DRX cycle in FIG. 10 is modified by the triggering equation to 16 ms, 16 ms, and 18 ms when T=2 ms.

### Mismatch at SFN Wrap-Around:

SFN ranges from 0 to 1023 and the subframe number ranges from 0 to 9. The term [(SFN×10)+subframe number] ranges from 0 to 10239 and it returns to 0 to repeat again when it reaches 10239. Therefore, if the DRX cycle length is not a factor of 10240 ms, each time the SFN value wraps around, the equation will incorrectly calculate the start of the DRX cycle and then propagate this offset to the next cycle. To solve the mismatch at SFN wrap-around, a counter C for the number of wrap-around is added to the above equation as:

$$[ ( ( 1024 \times C + SFN ) \times 10 ) + subframe number ] mod ( drx - ShortCycle ) = ( drx - StartOffset + {δ}_{n} ) mod ( drx - ShortCycle ) ,$$

where δₙ=round [n·(burst arrival interval−DRX cycle)] and C counts the number of wrap-around.

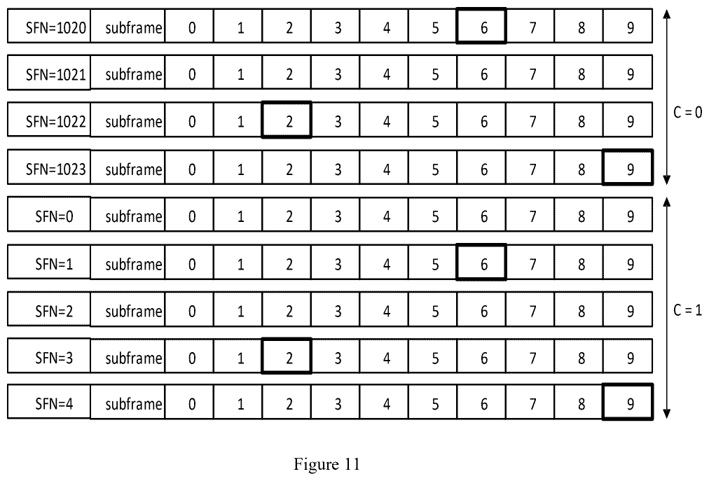

Take the above case as an example where the burst arrival interval is 16.67 ms, the short DRX is configured as 16 ms, and the drx-StartOffset is configured as 6. FIG. 11 shows that the DRX cycle before SFN wrap-around (i.e., C=0) continues without mismatch after the SFN wraps around. (i.e., C=1),
when the DRX cycle is configured with a real number.

The modulo operation could be defined for any two real numbers x, y with y #0 by the following equation:

$$x mod y = x - y \cdot ⌊ \frac{x}{y} ⌋$$

When the DRX cycle (i.e., drx-ShortCycle) is configured with a real number (e.g., 33.33 ms, 16.67 ms, 11.11 ms, 8.33 ms for 30, 60, 90, 120 fps respectively), the triggering equation may be modified as:

$$[ ( SFN \times 10 ) + subframe number ] - a \cdot ⌊ \frac{[ ( SFN \times 10 ) + subframe number ]}{a} ⌋ = b - a \cdot ⌊ \frac{b}{a} ⌋$$

where a=drx-ShortCycle and b=drx-StartOffset.
because [(SFN×10)+subframe number] and drx-StartOffset are always integers, the above triggering equation can be modified to:

$$⌊ [ ( SFN \times 10 ) + subframe number ] - a \cdot ⌊ \frac{[ ( SFN \times 10 ) + subframe number ]}{a} ⌋ ⌋ = ⌊ b - a \cdot ⌊ \frac{drx - StartOffset}{a} ⌋ ⌋$$

The modified equation could reduce the computation complexity for modulo operation for real numbers.

### Modified the DRX Cycle by Configuring Multiple DRX Configurations:

Multiple DRX configurations for XR/CG service may be specified in standard specification. The multiple DRX configurations having a same cycle but with different start offsets compose one DRX configuration that eliminates the mismatch between the burst arrival interval and the DRX cycle. In addition, DRX timers for each of the multiple DRX configurations may be separately configured. Further details are provided below.

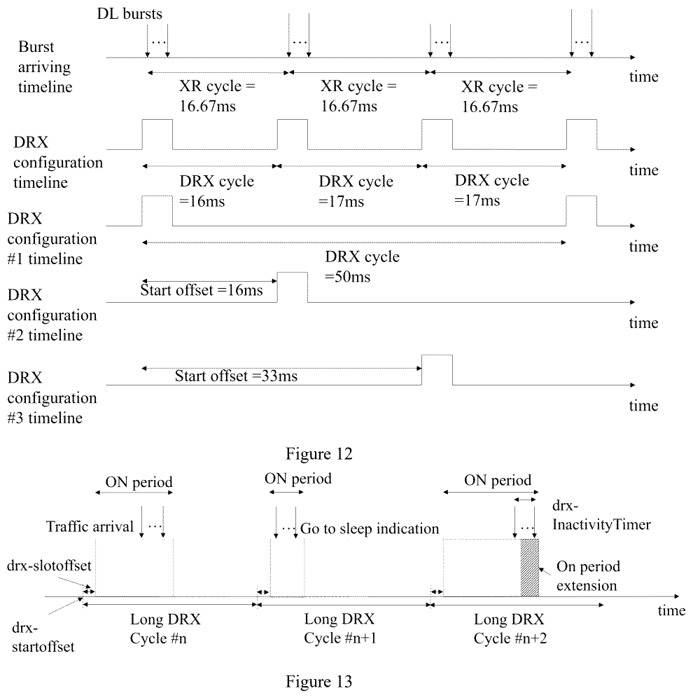

According to FIG. 8, the DRX configuration with {16 ms, 17 ms, 17 ms}cycles may also be composed by multiple DRX configurations. Considering the use case of 60 fps, it means that there are 3 video frames arriving every 50 ms. We can configure one DRX configuration for each video frame such that the three DRX configurations have the same cycles (i.e., 50 ms) but with different start offsets (i.e., Oms, 16 ms, 33 ms). FIG. 12 illustrates how the three DRX configurations compose one DRX configuration. The advantage of this method is that the legacy parameters (e.g., DRX cycle, start offset, slot offset, etc.) could be reused. In addition, DRX timers (e.g., drx-InactivityTimer and drx-onDurationTimer) for each DRX configuration should be separately configured.

### Handling Jitter of Traffic Arrival Time:

Large ON period is configured to cover most of the arrival times. For a video stream of the XR/CG service, a DRX cycle is configured. The DRX cycle is configured with a DRX ON period for transmission of at least one of control information or data and a DRX OFF period during which the transmission is suspended, and specifically the DRX ON period of the DRX cycle is extended to cover an arrival interval of at least one data burst plus a data arrival jitter. The data arrival jitter may be provided by a user equipment (UE) and/or a network entity in a 5G core network to a base station for configuring the DRX ON period. In response to a go-to-sleep indication on the DRX ON period, the DRX ON period may transition to the DRX OFF period. In response to a data packet transmission during the DRX ON period, a timer may be activated or re-activated, and the extended DRX ON period may be further extended till the time when the timer is expired. The DRX cycle with the extended DRX ON period may include a long DRX cycle and associated short DRX cycles, in which the long DRX cycle and the associated short DRX cycles are configured as a DRX configuration set. The DRX configuration set may be a DRX configuration with at least two levels including an outer level corresponding to the long DRX cycle and an inner level corresponding to the associated short DRX cycles. In this configuration, the transmission of the at least one of control information or data may be only carried out during ON periods of the associated short DRX cycles. In an aspect, in response to a go-to-sleep indication on ON period of one of the associated short DRX cycles, subsequent short DRX cycles may be turned off. In another aspect, a first timer of the long DRX cycle may be used to extend ON period of the long DRX cycle, and a second timer of the short DRX cycle may be used to extend ON period of the short DRX cycle. Further details are provided below.

The XR/CG's traffic arrival time is not deterministic but jittered by a value. Based on study of 3GPP Technical Report (TR) 38.838, the jitter follows truncated Gaussian distribution with ranges of [−4 ms, 4 ms] or [−5 ms, 5 ms]. It means that the XR/CG's traffic may arrive 4 ms/5 ms before or after the ON period starts. In order to overcome the impact of jitter, the most straightforward way is to extend the ON period to cover all the possible XR/CG arrival times. As shown in FIG. 13, the ON period is configured (i.e., by appropriately configuring drx-startoffset and drx-onDurationTimer) to start 4 ms/5 ms earlier and/or end 4 ms/5 ms later. However, the UE needs to continuously monitor the PDCCH to check the traffic arrival during the ON period such that the power consumption will increase with the extension of ON period. To reduce the power consumption, the ‘go to sleep’ indication (e.g., DRX Command MAC CE, Long DRX Command MAC CE, or DCI based PDCCH skipping indication) could be used to request the UE to enter OFF period if the UE completes the transmission early in the ON period. In case the XR/CG traffic arrives late during the ON period, the drx-InactivityTimer could be used to extend the ON period to finish the transmission. The drx-InactivityTimer is activated/re-activated when receiving a packet during the ON period, and the UE enters OFF period when the drx-InactivityTimer is expired.

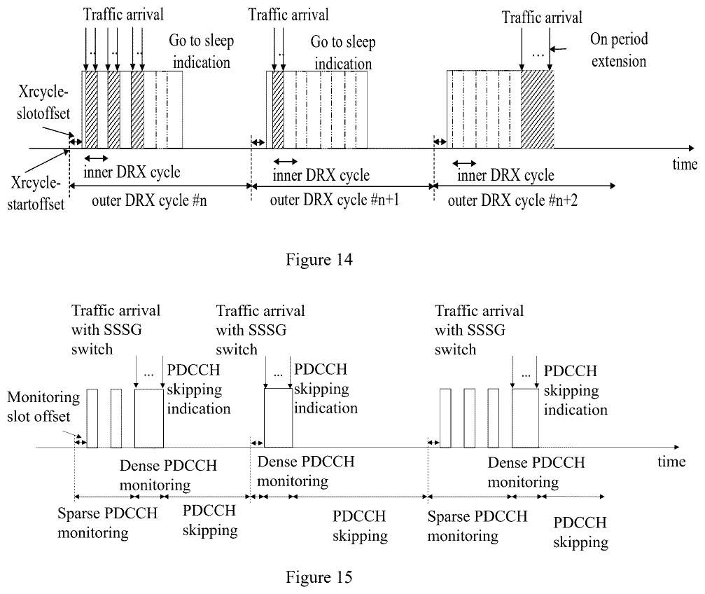

It may be inefficient to extend the ON period to receive only one traffic burst within the ON period. An alternative way is to configure several short DRX cycles to cover the jitter. The long DRX cycle and the associated short DRX cycles in FIG. 14 may be configured as a DRX configuration set. The DRX configuration set may reuse the existing DRX configuration or be configured as a specific configuration for XR/CG service. The DRX configuration set may be a two-level DRX configuration where the outer level is configured to resolve the traffic arrival jitter and the inner level is configured to accommodate the traffic burst arrival and reduce the power consumption of PDCCH monitoring. The UE only needs to wake up in the relatively short ON periods of the inner DRX cycles to monitor the PDCCH. For example, when the XR/CG traffic pattern is 60 fps with a jitter of [−4 ms, 4 ms], the long DRX cycle in FIG. 14 can be configured as 16 ms and the short DRX cycle is configured as 2 ms (i.e., the ON period of the inner DRX cycle is 1 ms). The number of the short DRX cycle can be configured as 4 (i.e., drx-ShortCycleTimer=4) to cover the jitter of one traffic burst. In such a configuration, when the XR/CG traffic arrives during the OFF period of the inner DRX cycle, the maximum waiting time for transmission is 1 ms. To further reduce the power consumption, the ‘go to sleep’ indication (e.g., DRX Command MAC CE, Long DRX Command MAC CE, or DCI based PDCCH skipping indication) could be used to request the UE to enter the OFF period and turn off the subsequent short DRX cycle(s) after completing the transmission during the ON period. Note that the “go to sleep” indication may be transmitted from the gNB to the UE for the DL transmission (i.e., the gNB needs to know the end of the burst arrivals) and may be transmitted from the UE to the gNB for the UL transmission. (i.e., the UE needs to know the end of the burst arrivals) In case the XR/CG traffic requires more than 1 ms radio resource for transmission, the ON period of the outer XR/CG cycle and the inner DRX cycle may be extended to finish the data transmission. The drx-InactivityTimer of the outer DRX cycle could be used to extend the ON period of the outer DRX cycle, and the drx-InactivityTimer of the inner DRX cycle could be used to extend the ON period of the inner DRX cycle.

For a video stream of the XR/CG service, during the ON period, short DRX cycles or different search spaces are configured to reduce the time for PDCCH monitoring. Specifically, PDCCH monitoring periodicity is dynamically changed based on a search space set group (SSSG) switch indication. In particular, at least two search spaces are configured, one of the at least two search spaces is for sparse PDCCH monitoring and the other one of the at least two search spaces is for dense PDCCH monitoring. The PDCCH monitoring is carried out with a first monitoring periodicity during the sparse PDCCH monitoring and with a second monitoring periodicity during the dense PDCCH monitoring, and first monitoring periodicity is larger than the second monitoring periodicity. The sparse PDCCH monitoring may be configured in response to no traffic arrival, and the dense PDCCH monitoring may be configured in response to traffic arrival. In response to the SSSG switch indication, the sparse PDCCH monitoring may be changed to the dense PDCCH monitoring or the dense PDCCH monitoring may be changed to the sparse PDCCH monitoring. In an example, the SSSG switch indication may be to configure the dense PDCCH monitoring in response to traffic arrival, and the SSSG switch indication may be to configure the sparse PDCCH monitoring in response to finished traffic transmission. In an aspect, in response to a PDCCH skipping indication via a Layer 1 signaling or a go-to-sleep indication via a higher layer signaling, subsequent PDCCH monitoring may be skipped. In another aspect, a timer may be configured during the dense PDCCH monitoring, and the dense PDCCH monitoring may be switched to the sparse PDCCH monitoring when the timer is expired. In an embodiment, the PDCCH monitoring periodicity may be dynamically changed during a discontinuous reception (DRX) ON period. The DRX ON period may be ended by a PDCCH skipping indication via a Layer 1 signaling or a go-to-sleep indication via a higher layer signaling. Further details are provided below.

FIG. 15 shows an alternative way to periodically monitor PDCCH based on search space set group (SSSG) switching. During the ON period of XR/CG cycle, the gNB could dynamically adjust the PDCCH monitoring periodicity for the UE based on an SSSG switch indication. The gNB may configure the UE with two (or more than two) search spaces one of which is for sparse PDCCH monitoring and the other one of which is for dense PDCCH monitoring. Within the sparse PDCCH monitoring duration, the UE monitors the PDCCH with large monitoring slot periodicity (e.g., 2 or 4 slots). When the ON period of the XR/CG cycle starts, sparse PDCCH monitoring may be configured for the UE. It is most likely no traffic arrives at the beginning of the ON period, especially when long period is configured to resolve the traffic arrival jitter. The sparse PDCCH monitoring is like a DRX configuration with large periodicity. The difference is that SSSG switching is controlled by a PHY layer indication (e.g., DCI), but DRX cycle switching is controlled by an RRC message. SSSG switching could react to the traffic arrival faster than DRX cycle switching and the gNB could dynamically adjust the PDCCH monitoring periodicity to reduce UE power consumption. When the traffic arrives, the gNB indicates search space set group (SSSG) switching to adjust the PDCCH monitoring with small monitoring slot periodicity (e.g., 1 slot) and the UE could receive the traffic in the associated Physical Downlink Share Channel (PDSCH) as soon as possible. After completing the traffic burst transmission during the ON period, the gNB may transmit a PDCCH skipping indication or a go-to-sleep indication to the UE to skip the subsequent PDCCH monitoring. An alternative way is to let the UE continuously monitors the PDCCH until end of the ON period. After the OFF period, the gNB may indicate SSSG switching to the UE again to trigger the UE with sparse PDCCH monitoring. A timer may be configured together with the PDCCH skipping indication. If the timer is configured, the UE could autonomously switch back to sparse PDCCH monitoring when the timer is expired. The advantage of this method is that the gNB could dynamically adjust the PDCCH monitoring periodicity to achieve UE power saving.

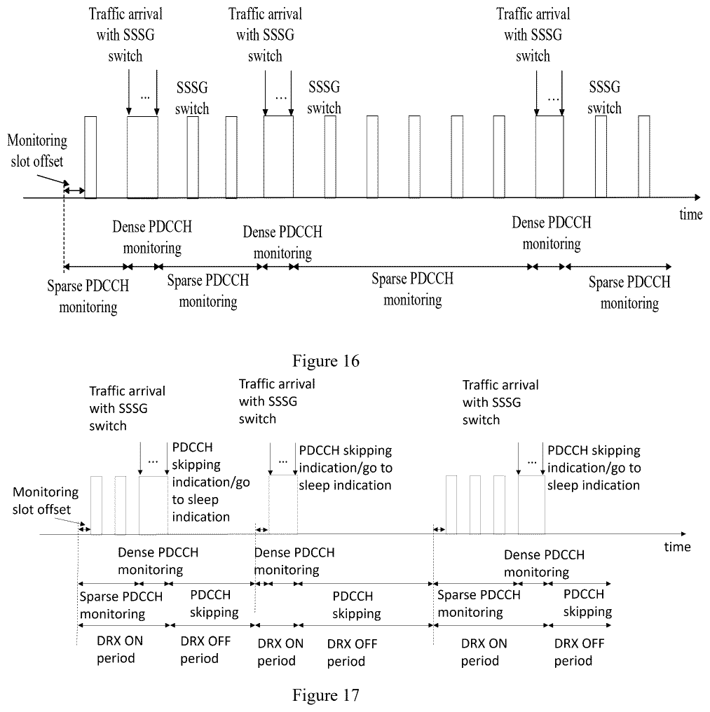

FIG. 16 shows an alternative PDCCH-based power saving configuration. In this configuration, the PDCCH skipping may be replaced by sparse PDCCH monitoring and the traffic arrival may be monitored even it arrives during the PDCCH skipping interval. Like the mechanism in FIG. 15, when the traffic arrives, the gNB indicates SSSG switching to configure the UE with dense PDCCH monitoring. When the traffic transmission is finished, the gNB indicates SSSG switching to configure the UE with sparse PDCCH monitoring. This method sacrifices a little power consumption in exchange for being able to detect traffic due to jitter.

Note that PDCCH-based power saving could be combined with DRX-based power saving to get better power saving gain. FIG. 17 shows the combination of PDCCH-based power saving and DRX-based power saving. During the DRX ON period (i.e., the grey rectangle), the gNB could dynamically adjust the PDCCH monitoring periodicity. When the gNB determines the traffic burst transmission is completed in the ON period, it could end the ON period by transmitting PDCCH skipping indication or go to sleep indication. The UE may wake up again to monitor the PDCCH based on the time interval in the PDCCH skipping indication.

### Supporting Multi-Modality Service for XR/CG:

Multiple DRX configurations for XR/CG service may be specified in standard specification. Specifically, the multiple DRX configurations with different start offsets and different DRX cycles are configured, and one of the multiple DRX configurations is activated at a time. That is, a current DRX configuration is deactivated and another DRX configuration is activated. For uplink (UL) bursts, an indication may be used to notify an end of the UL bursts. The indication may include a buffer status report (BSR) or a DRX switch Medium Access Control (MAC) control element (CE). Each of the multiple DRX configurations may have its own parameters, and the parameters include at least one of ON period interval, ON period extension, long DRX cycle, short DRX cycle, and start offset. Further details are provided below.

For the XR/CG applications, tactile and multi-modal data (e.g., audio, video, and haptic data) may be delivered to the UE at a specific time. Therefore, each XR/CG traffic may include multiple streams and each stream may have its burst arrival periodicity with a corresponding burst arrival time.

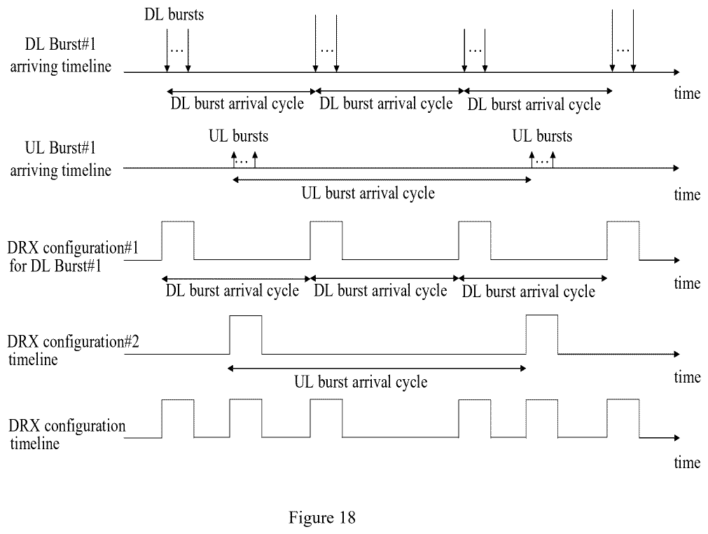

As shown in FIG. 18, it is more efficient to configure multiple DRX cycles to accommodate the XR traffic. In 3GPP TS38.331, the information element (IE) DRX-ConfigSecondaryGroup is used to configure DRX related parameters for the second DRX group. However, the DRX-ConfigSecondaryGroup IE is only used for the cell other than the first cell, and only the drx-onDurationTimer (i.e., ON period interval) and drx-InactivityTimer (i.e., ON period extension) could be configured for the second DRX group. The DRX cycle, start offset and slot offset of the second DRX group is the same as ones of the first DRX group. It is not suitable to reuse the DRX-ConfigSecondaryGroup IE to configure the multiple video streams in the XR/CG traffic because the multiple video streams may have different periodicities and arrival times. Therefore, the DRX configuration(s) with different start offsets and different DRX cycles should be configured for the XR/CG traffic.

Note that if only one (active) DRX configuration could be activated at a time, a change request may be needed for switching the DRX configuration. The UE may be configured with multiple DRX configurations by the gNB (or by the network) in advance, and then one of the DRX configurations is activated by the gNB for the UE at a time. The gNB may activate the DRX configuration by sending a downlink control information (DCI) or a MAC control element (CE) (e.g., DRX switch MAC CE) to the UE. For UL bursts where the gNB may not know the end time of UL bursts (i.e., only the UE knows whether all the UL bursts have been transmitted), the UE may transmit an indication (e.g., buffer status report (BSR), request DRX switch MAC CE, etc.) to the gNB to notify the end of UL bursts, and then the gNB could deactivate the current DRX configuration and activate another DRX configuration for the UE.

Table 5 below is an example for the second DRX configuration which has its own ON period interval (i.e., drx-onDurationTimer), ON period extension (i.e., drx-InactivityTimer), long DRX cycle (i.e., drx-LongCycleStartOffset), short DRX cycle (i.e., drx-ShortCycle-r18), and start offset (i.e., drx-LongCycleStartOffset). As shown in Table 6, when the DRX-ConfigSecondaryGroup-r18 is setup in MAC-CellGroupConfig, the second DRX configuration could be configured for Rel-18 XR/CG with multiple video streams scenario.

TABLE 5
DRX-ConfigSecondaryGroup information element.

| | |
|---|---|
| DRX-ConfigSecondaryGroup-r18 ::= | SEQUENCE { |
| drx-onDurationTimer | CHOICE { |
| | subMilliSeconds INTEGER (1..31), |
| | milliSeconds ENUMERATED { |
| | ms1, ms2, ms3, ms4, ms5, ms6, ms8, ms10, ms20, ms30, ms40, |

ms50, ms60, ms80, ms100, ms200, ms300, ms400, ms500, ms600, ms800, ms1000, ms1200,
ms1600, spare8, spare7, spare6, spare5, spare4, spare3, spare2, spare1 }

| | |
|---|---|
| | }, |
| drx-InactivityTimer | ENUMERATED { |
| | ms0, ms1, ms2, ms3, ms4, ms5, ms6, ms8, ms10, ms20, ms30, ms40, |

ms50, ms60, ms80, ms100, ms200, ms300, ms500, ms750, ms1280, ms1920, ms2560, spare9,
spare8, spare7, spare6, spare5, spare4, spare3, spare2, spare1 }

| | |
|---|---|
| drx-HARQ-RTT-TimerDL | INTEGER (0..56), |
| drx-HARQ-RTT-TimerUL | INTEGER (0..56), |
| drx-RetransmissionTimerDL | ENUMERATED { |
| | sl0, sl1, sl2, sl4, sl6, sl8, sl16, sl24, sl33, sl40, sl64, sl80, sl96, sl112, |

sl128, sl160, sl320, spare15, spare14, spare13, spare12, spare11, spare10, spare9, spare8, spare7,
spare6, spare5, spare4, spare3, spare2, spare1 },

| | |
|---|---|
| drx-Retransmission TimerUL | ENUMERATED { |
| | sl0, sl1, sl2, sl4, sl6, sl8, sl16, sl24, sl33, sl40, sl64, sl80, sl96, sl112, |

sl128, sl160, sl320, spare15, spare14, spare13, spare12, spare11, spare10, spare9, spare8, spare7,
spare6, spare5, spare4, spare3, spare2, spare1 },

| | |
|---|---|
| drx-LongCycleStartOffset | CHOICE { |
| ms100 | INTEGER(0..99), |
| ms200 | INTEGER(0..199), |
| ms400 | INTEGER(0..399), |
| ms800 | INTEGER(0..799), |
| ms1000 | INTEGER(0..999), |
| ms2000 | INTEGER(0..1999), |
| ms4000 | INTEGER(0..3999), |
| ms8000 | INTEGER(0..7999), |
| ms10000 | INTEGER(0..9999), |

},

| | |
|---|---|
| shortDRX | SEQUENCE { |
| drx-ShortCycle-r18 | ENUMERATED { |
| | ms33dot33, ms16dot67, ms11dot11, ms8dot33, spare4, spare3, |
| spare2, spare1 }, | |
| drx-ShortCycleTimer | INTEGER (1..16) |
| } | OPTIONAL, -- Need R drx-SlotOffset |
| INTEGER (0..31) | |
| } | |

TABLE 6
MAC-CellGroupConfig information element

| MAC-CellGroupConfig ::= | SEQUENCE { | |
|---|---|---|
| drx-Config | SetupRelease { DRX-Config } | OPTIONAL, -- Need M |

...

| | |
|---|---|
| drx-ConfigSecondaryGroup-r18 | SetupRelease { DRX-ConfigSecondaryGroup } |

OPTIONAL -- Need M
}

### Supporting Multi-Modality Service by DRX and SPS/CG:

In order to support a multi-modality service, one DRX configuration, one SPS configuration and one CG configuration may be configured. That is, the DRX configuration for a variable-sized stream, the SPS configuration for a DL fixed-sized stream and the CG configuration for an UL fixed-sized stream are configured for the multi-modality service. In the configuration(s), SPS/CG operation is independent from DRX operation. That is, SPS/CG resources can be scheduled during DRX OFF period, and data transmission on the SPS/CG resources is allowed even during the DRX OFF period.

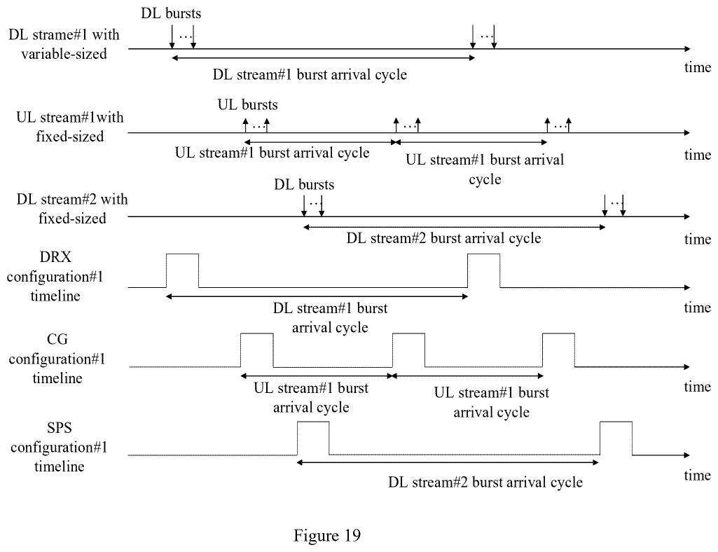

When a multi-modality service contains only one variable-sized stream (e.g., video stream) and other streams are fixed-size (e.g., audio, and haptic feedback), the gNB may configure one DRX configuration for the variable-sized stream, a semi-persistent scheduling (SPS) configuration for the downlink (DL) fixed-sized stream, and a configured grant (CG) configuration for the uplink (UL) fixed-sized stream. SPS/CG is a continuous pre-scheduled resource with fixed-size for DL/UL transmission. SPS/CG operation is independent from DRX operation, which means that SPS/CG resource could be scheduled during DRX OFF period and allow the UE to wake up to receive/transmit data on SPS/CG resources even if the UE is in DRX OFF period. FIG. 19 shows the DRX, SPS, and CG configurations are configured for a multi-modality service. The procedures of configuring DRX configuration(s) for a UE:

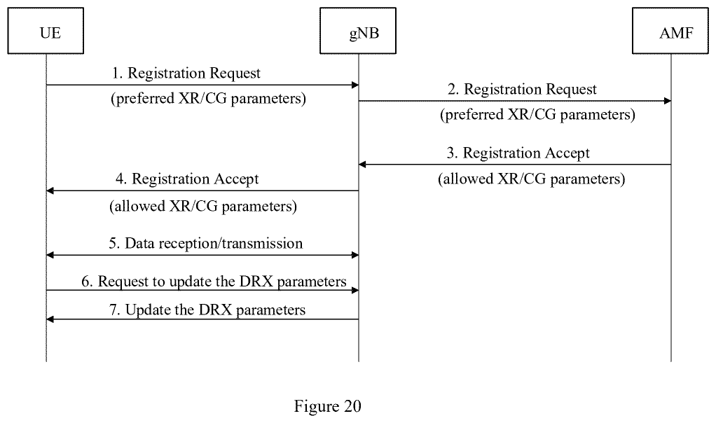

FIG. 20 shows the procedure of DRX configuration for a UE.

Step 1: The UE transmits a Registration Request message to the gNB. The Registration Request message may include the US Assistance Information carrying UE preferred DRX parameters. The UE preferred DRX parameters may include the preferredDRX-LongCycle, the preferredDRX-InactivityTimer, preferredDRX-ShortCycle, and/or preferredDRX-ShortCycleTimer.

Note 1: The preferredDRX-LongCycle and/or preferredDRX-ShortCycle may include the non-integer periodicities (e.g., 8.33 ms, 11.11 ms, 16.67 ms, 33.33 ms etc.) for XR/CG traffic.

Note 2: The UE Assistance Information is optional. Without this information, the AMF could also determine the DRX parameters based on the traffic information received from the XR/CG application server.

Note 3: When the UE transmits multi-modal data traffic, the US Assistance Information may carry multiple DRX parameters set for the multi-modal data traffic. The DRX parameters may include a set of preferredDRX-LongCycle, the preferredDRX-InactivityTimer, preferredDRX-ShortCycle, preferredDRX-ShortCycleTimer, drx-StartOffset, etc.

Step 2: The gNB forwards the Registration Request message with the UE preferred DRX parameters to the Access and Mobility Management Function (AMF).

Step 3: The AMF determines if the preferred DRX parameters could be allowed. The AMF replies a Registration Accept message with allowed DRX parameters.

Note 1: The AMF may be informed with traffic information from the XR/CG application server. The traffic information may include media codec, traffic burst size, traffic periodicity, traffic rate, traffic jitter (e.g., jitter distribution includes mean and standard deviation), number of (continuous) packets, etc. The AMF uses the information to determine the allowed DRX parameters.

Note 2: The AMF may reply with allowed DRX parameters for multiple DRX configuration.

Note 3: The AMF may be informed with information about PDU set from the session management function (SMF)/policy control function (PCF) and provide the information to the gNB for configuring DRX. The information may include PDU set periodicity (i.e., start time of the first PDU and end time of the last PDU in a PDU set), PDU set size (e.g., the maximum or minimum size of a PDU size), a number of PDUs in a PDU set (i.e., number of IP packets for an I/P/B-frame), PDU set QoS parameters (e.g., PDU set delay budget and PDU set error rate), arrival jitter of the PDUs in a PDU set (e.g., mean and standard deviation of the jitter distribution),

Step 4: The gNB forwards the Registration Accept message to the UE. The allowed DRX parameters may be configured by the RRC messages. (e.g., RRCReconfiguration, RRCResume, or RRCSetup message)

Note 1: As described in sections 3 and 5, the gNB may configure more than one DRX configuration for the UE.

Note 2: When more than one DRX configuration is configured, the gNB may activate one of the DRX configurations for the UE at a time. The gNB may active the DRX configuration by sending a RRC message, a MAC CE, or a DCI to the UE.

Step 5: The UE is configured with the allowed DRX parameters. The UE wakes up at the ON period based on the methods in sections 1-5 and transmits/receives data during the ON period.

Step 6: When the UL traffic characteristics (e.g., traffic periodicity, traffic burst size, traffic start/end time, traffic jitter, service type etc.) are changed, the UE may request to update the DRX parameters by a RRC message, a MAC CE, or a UCI. When more than one DRX configuration is configured, the UE may request to activate another DRX configuration by sending a RRX message, a MAC CE, or the UCI to the gNB.

Step 7: The gNB updates the DRX parameters by the RRC messages. (e.g., RRCReconfiguration, RRCResume, or RRCSetup message) When more than one DRX configuration is configured, the gNB may activate another DRX configuration for the UE by sending a RRC message, a MAC CE, or a DCI to the UE.

Please note that the above steps or procedure names (i.e., registration procedure) are only an example to complete the DRX configuration and should not be regarded as a limitation for DRX configuration. The above DRX configuration may also be configured through other Non-Access-Stratum (NAS) or RRC procedures.

Commercial interests for some embodiments are as follows. 1. solving issues in the prior art. 2. Realize DRX enhancements. 3. saving power consumption. 4. supporting multi-modality service 5. providing a good communication performance. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR unlicensed band communications. Some embodiments of the present disclosure propose technical mechanisms.

The embodiment of the present application further provides a computer readable storage medium for storing a computer program. The computer readable storage medium enables a computer to execute corresponding processes implemented by the UE/BS in each of the methods of the embodiment of the present disclosure. For brevity, details will not be described herein again.

The embodiment of the present application further provides a computer program product including computer program instructions. The computer program product enables a computer to execute corresponding processes implemented by the UE/BS in each of the methods of the embodiment of the present disclosure. For brevity, details will not be described herein again.

The embodiment of the present application further provides a computer program. The computer program enables a computer to execute corresponding processes implemented by the UE/BS in each of the methods of the embodiment of the present disclosure. For brevity, details will not be described herein again.

Although not shown in detail any of the devices or apparatus that form part of the network may include at least a processor, a storage unit and a communications interface, wherein the processor unit, storage unit, and communications interface are configured to perform the method of any aspect of the present invention. Further options and choices are described below.

The signal processing functionality of the embodiments of the invention especially the gNB and the UE may be achieved using computing systems or architectures known to those who are skilled in the relevant art. Computing systems such as, a desktop, laptop or notebook computer, hand-held computing device (PDA, cell phone, palmtop, etc.), mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor including the computer system to cause the processor to perform specified operations. Such instructions, generally referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors or configurable module components such as field programmable gate array (FPGA) devices.

Thus, the elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1. A method for enabling a wireless communication device to access services provided by a Radio Access Network, wherein a discontinuous reception (DRX) cycle is configured with a DRX ON period for transmission of at least one of control information or data and a DRX OFF period during which the transmission is suspended, and wherein the DRX cycle is a specific DRX cycle having a non-integer duration.

2. The method of claim 1, wherein the specific DRX cycle is configured for a specific use case and is a non-integer value listed in an information element.

3-4. (canceled)

5. The method of claim 1, wherein the non-integer duration comprises 33.33, 16.67, 11.11 or 8.33 in a unit of microsecond.

6. (canceled)

7. The method of claim 1, wherein a non-integer short DRX cycle and a corresponding non-integer long DRX cycle are configured in an information element, and wherein a duration of the corresponding non-integer long DRX cycle is an integer multiple of a duration of the non-integer short DRX cycle.

8-11. (canceled)

12. The method of claim 1, wherein a triggering equation is used for implementing a non-integer DRX cycle.

13-22. (canceled)

23. The method of claim 1 wherein a non-integer DRX cycle based on a burst arrival interval is provided by a user equipment (UE) and/or an application server to a base station for configuring the non-integer DRX cycle.

24-26. (canceled)

27. The method of claim 1, wherein the non-integer DRX cycle can be applied to a short DRX cycle or a long DRX cycle.

28. The method of claim 12, wherein a counter for a number of system frame number (SFN) wrap-around is added to the triggering equation.

29. The method of claim 1, wherein a data arrival jitter is provided by a user equipment (UE) and/or a network entity in a 5G core network to a base station (BS) for configuring the DRX ON period.

30. The method of claim 1, wherein in response to a data packet transmission during the DRX ON period, a timer is activated or re-activated, and the DRX ON period is extended till the time when the timer is expired.

31. A user equipment (UE), comprising:
a memory, configured to store program instructions;
a transceiver, configured to transmit and receive data; and
a processor, coupled to the memory and the transmitter, configured to call and run the program instructions stored in a memory, to cooperate with the memory to execute a method for enabling a wireless communication device to access services provided by a Radio Access Network, wherein a discontinuous reception (DRX) cycle is configured with a DRX ON period for transmission of at least one of control information or data and a DRX OFF period during which the transmission is suspended, and wherein the DRX cycle is a specific DRX cycle having a non-integer duration.

32. The UE of claim 31, wherein a triggering equation is used for implementing a non-integer DRX cycle.

33. The UE of claim 32, wherein a counter for a number of system frame number (SFN) wrap-around is added to the triggering equation.

34. The UE of claim 31, wherein a data arrival jitter is provided by the UE to a base station (BS) for configuring the DRX ON period.

35. The UE of claim 31, wherein in response to a data packet transmission during the DRX ON period, a timer is activated or re-activated, and the DRX ON period is extended till the time when the timer is expired.

36. A base station (BS), comprising:
a memory, configured to store program instructions;
a transceiver, configured to transmit and receive data; and
a processor, coupled to the memory and the transmitter, configured to call and run the program instructions stored in a memory, to cooperate with the memory to execute a method for enabling a wireless communication device to access services provided by a Radio Access Network, wherein a discontinuous reception (DRX) cycle is configured by the BS with a DRX ON period for transmission of at least one of control information or data and a DRX OFF period during which the transmission is suspended, and wherein the DRX cycle is a specific DRX cycle having a non-integer duration.

37. The BS of claim 36, wherein the BS is used to configure the specific DRX cycle as a non-integer short DRX cycle and/or a corresponding non-integer long DRX cycle through an information element.

38. The BS of claim 37, wherein a duration of the non-integer long DRX cycle is an integer multiple of a duration of the non-integer short DRX cycle.

39. The BS of claim 37, wherein the non-integer short DRX cycle and the non-integer long DRX cycle comprise 33.33, 16.67, 11.11 or 8.33 in a unit of microsecond.

40. The BS of claim 36, wherein the BS is configured to receive a data arrival jitter from a user equipment (UE) and/or a network entity in a 5G core network for configuring the DRX ON period.
